(19) United States
(12) Patent Application Publication
(10) Pub. No.: US 2008/0277178 A1
(43) Pub. Date: Nov. 13, 2008

(54) Steering wheel assembly with centrally located stationary support member

(75) Inventors: Valerio Poli, Villa Barolomea (IT); Andrea Anselmi, Tregnago (IT); Roberto Ridolfi, Tregnago (IT); Adolfo Ridolfi, Tregnago (IT)

Correspondence Address: KEY SAFETY SYSTEMS, INC.;PATENT DEPARTMENT, 5300 ALLEN K BREED HIGHWAY, LAKELAND, FL, 33811-1130, US

(73) Assignee: KEY SAFETY SYSTEMS, INC., Sterling Heights, MI (US)

(21) Appl. No.: 12/022,345

(22) Filed: Jan. 30, 2008

(30) Foreign Application Priority Data
May 9, 2007 (EP) 07009274.7

(51) Int. Cl. B62D 1/10; B60R 21/20; B62D 1/04

(52) U.S. Cl. 180/78; 74/552; 280/731

(57) ABSTRACT

A steering wheel assembly has a steering wheel armature, a hub portion and spokes. The hub portion is fixable to a conventional steering column shaft. The steering wheel assembly has a first drum supported on the steering column shaft, to freely rotate about only the axis of the steering column shaft. A second drum is freely rotatable with respect to the first drum only about a second axis. The second axis is parallel to and spaced apart from or incident to of the steering column shaft. Stationary means are provided for supporting the second drum on the first drum. Both the first drum and the second drum are rotated around their respective axes by the spokes engaging their sidewalls. The support provides a stationary support member onto which an airbag module or other devices can be mounted.

### FIELD OF THE INVENTION

The present invention relates to a steering wheel assembly having a centrally located stationary support member for receiving a driver's side airbag module that does not rotate with the steering wheel.

### BACKGROUND OF THE INVENTION

A conventional airbag module is mounted on the hub of a vehicle steering wheel, and the hub is coupled to a steering shaft. The airbag module rotates in unison with the steering wheel. Since the deployment of the airbag may occur at different rotational orientations of the steering wheel with respect to the vehicle driver, the airbag has to be circular or symmetrical to always provide a protection surface of the same shape to the driver.

Recently steering wheel assemblies have been provided that allow an airbag module to remain stationary with respect to the vehicle during rotation of the steering wheel. This type of airbag module is known as a stationary driver's side airbag module. Stationary driver's side airbag modules may provide airbags having shapes other than circular, since there is no rotation of the airbag module the same with respect to the driver. Stationary driver's side airbag modules allow localized increases of the airbag volume, so airbags may be designed to fit the internal volume of a particular vehicle when deployed to better protect the driver regardless of the rotational orientation of the steering wheel.

### DISCUSSION OF THE PRIOR ART

US 2003/0067147 A1 discloses a stationary driver's side airbag that comprises a rotatable steering wheel encompassing an accessible space and coupled to the respective shaft by a planetary gear system. The planetary gear system transfers torque applied to the steering wheel ring portion directly to the steering shaft. An airbag module is positioned within the accessible space encompassed by the steering wheel and remains stationary during rotation of the steering wheel.

DE 2 131 902 discloses a steering wheel provided with a non-rotating driver's side airbag module. Rotation of the steering wheel is transmitted to the steering shaft either directly, by matching the internal teeth of the steering hub with the external teeth of the shaft, or indirectly by way of planetary gears interposed between the hub teeth and the shaft teeth. In both cases a space is left between the shaft and the steering hub for housing of both the electric wires and the stationary support members to which the driver's side airbag module is fixed. This is achieved for the steering hub and the respective shaft a gear ratio different than 1:1, i.e. by providing the hub with a greater diameter than the shaft and using the gap between them for the passage of the wires and the stationary support members.

Solutions employing planetary gears, such as shown in FIG. 2 of DE 2 131 902, have several drawbacks. First, the steering wheel is not directly mounted on the steering shaft leaving a discontinuity in the structure. Because of the increasing of the mechanical clearance that occurs as the gears wear with usage, rotation of the steering wheel does not match with the rotation of the steering shaft. When planetary gears are provided for connecting the steering hub to the steering shaft, it is necessary that the gears have exact dimensions to avoid damping of the force transmitted by the driver to the steering shaft or the occurring of an offset between the rotation angle of the steering wheel ring portion and the rotation of the steering shaft. If one of the stationary driver's side airbag module components has dimensions different from what is specified, a non-uniform rotation of the steering wheel ring portion may occur, for example due to the imperfect matching between the gears. Another drawback is that rotation of the steering shaft is in the opposite direction with respect to the rotation imparted by the driver to the steering wheel ring portion. The steering box of the vehicle has to be designed to overcome such a drawback to reverse the direction of rotation imparted by the steering shaft to the vehicle wheels. This leads to an increase in the vehicle production costs.

Prior art assemblies provided with gears for coupling the steering hub to the steering shaft are complicated and require high accuracy in the manufacture of the gears, increasing production time and costs.

DE 3 413 009 A1 discloses a steering wheel provided with a stationary driver's side airbag module wherein the steering wheel hub is directly coupled to a steering shaft in a conventional way. Two gears are provided for maintaining the driver's side airbag module stationary: a first gear matching the driver's side airbag module and a second gear matching the steering shaft. The first and the second gear are coupled to the same driving shaft that is rotatably lodged within a seat of the steering hub. When the driver rotates the steering wheel ring portion, the second gear is rotated about its own axis by the steering shaft and is also rotated about the steering wheel's axis of rotation by the steering wheel hub pushing the driving shaft. The same movement is transmitted by the driving shaft to the first gear. The gear ratio between the first gear and the driver's side airbag module and between the second gear and the steering shaft is chosen such that the driver's side airbag module rotates in the opposite direction with respect to the steering wheel ring portion, thereby remaining stationary. Such a solution requires two expensive “clock spring” connectors to be used for cabling the driver's side airbag module. A first connector is arranged on the steering shaft side of the hub and a second connector is arranged on the driver side of the hub, wired to the first one through the same hub. Another drawback of the solution according to DE 3 413 009 A1 is that the coupling of the driving shaft with the respective seat provided in the steering hub is critical. Inaccuracy in the machining of the seat may easily lead to misalignment of the first and second gears, thereby inducing small movements of the driver's side airbag module when the steering wheel ring portion is rotated.

U.S. Pat. No. 4,541,301 discloses a steering wheel assembly wherein the driver's side airbag module is kept stationary by a coiled element that screws or unscrews itself through a hub opening when the steering wheel is rotated clockwise or counter clockwise. The coiled element has a first end coupled to a stationary support member of the vehicle, a second end fixed to the module and wound around the steering shaft. The main drawback of such solution is that the coiled element does not sufficiently resist torsion to avoid the driver's side airbag module from incurring in small movements. In other words, due to its shape, the coiled element does not provide the necessary mechanical strength to maintain stationary the driver's side airbag module in all the operating conditions.

US 2003/0164060 A1 discloses a steering wheel for a vehicle provided with a second shaft other than the steering shaft. The second shaft is supported via bearings by a stationary hub, which includes a driver's side airbag module housing, such that it is rotatable about its own axis and is coupled to the steering shaft by an arm or an electronic actuator. The actuator includes a position sensor for detecting an angular displacement of the second shaft from a selected origin and producing a signal indicative of the angular displacement. Such a signal is transmitted to a road wheel actuator so that the position of the road wheels properly corresponds with the position of the steering wheel.

Generally, solutions based on a plurality of shafts are complicated and expensive. Duplication of the steering shaft facilitates passing the airbag module wiring harness easily inside the steering wheel column, but requires accurate design and assembly, expensive mechanical components and eventually electronic devices. Conventional assemblies provided with a plurality of gears or shafts are cumbersome. Vehicle steering columns, i.e. the various components of the vehicle around and comprising the steering shaft, have to be redesigned to accommodate such assemblies.

FR 2 833 916 discloses a steering wheel wherein the driver's side airbag module is kept quasi-stationary by an electric motor that rotates the driver's side airbag module in the opposite direction with respect to the steering wheel ring portion but for an initial angle. Such a solution is cumbersome, complicated, expensive and difficult to assemble and to set. Moreover an electronic control unit is needed to sense the rotation of the ring portion of the steering wheel and operate the motor consequently.

There is a need for a reliable and compact driver's side airbag module that does not rotate with the steering wheel and that can be fitted on existing steering columns without having to redesign the same.

The present invention provides a steering wheel having a centrally located stationary support member that overcomes the drawbacks of known solutions, being at the same time economical, reliable and simple to manufacture and assemble. The disclosed steering wheel has a centrally located stationary support member that overcomes the drawbacks of prior art solutions related to the mechanical coupling between the steering wheel and the steering shaft and at the same time overcomes the drawbacks of prior art solutions related to the electrical connections of the driver's side airbag module. The disclosed steering wheel has a centrally located stationary support member that can be directly mounted on common steering columns in a conventional way with no need for redesigning of the said steering columns.

### SUMMARY OF THE INVENTION

There is provided in accordance with the present invention a steering wheel assembly comprising a steering wheel armature, including a central hub portion fixable to a vehicle column shaft and a spoke and further comprising: a first drum that is freely rotatable only about the steering shaft's axis of rotation and has a sidewall, a second drum that has a sidewall and is freely rotatable about a second axis only, the second axis being either parallel to and spaced apart from the steering shaft's axis of rotation or intersects the steering shaft's axis of rotation, a stationary means for providing a stationary support member for attachment to a driver's side airbag module, and wherein both the first drum and the second drum are rotated around their respective axes by the spoke engaging their sidewalls.

A steering wheel assembly according to the present invention overcomes drawbacks of the prior art. The new steering wheel assembly does not require modification of the steering shaft, i.e. the steering wheel assembly is ready to be fitted on common steering shafts of conventional vehicles in a known way.

The new steering wheel assembly has no toothed gears, which are expensive and require strict tolerances.

The overall dimensions of the new steering wheel assembly are comparable to, or smaller than, those of a conventional steering wheel assembly provided with an airbag module.

### BRIEF DESCRIPTION OF THE DRAWINGS

FIG. 1 is a perspective view of a steering wheel and airbag module according to the present invention, in an assembled configuration.

FIG. 2 is a perspective front view of a first embodiment of the steering wheel assembly according to the present invention, in an assembled configuration.

FIG. 3 is a front view of a component of the steering wheel assembly assembly shown in FIG. 2.

FIG. 4 is a side view of the component shown in FIG. 3.

FIG. 5 is a perspective front view of a particular of the steering wheel assembly shown in FIG. 2.

FIG. 6 is a perspective side view of the particular of the steering wheel assembly shown in FIG. 5.

FIG. 7 is a perspective front view of a second embodiment of the steering wheel assembly according to the present invention.

FIG. 8 is a front view of a component of the steering wheel assembly shown in FIG. 7.

FIG. 9 is a side view of the component shown in FIG. 8.

FIG. 10 is a perspective front view of the steering wheel assembly shown in FIG. 7.

FIG. 11 is a perspective side view of the steering wheel assembly shown in FIG. 10.

FIG. 12 is a perspective view of the armature of the steering wheel assembly.

FIG. 13 is a perspective view of a detail of a steering wheel assembly.

FIG. 14 is a perspective view of a detail of the embodiment shown in FIGS. 5 and 6.

FIG. 15 is a perspective view of a detail of the embodiment shown in FIGS. 10 and 11.

### DETAILED DESCRIPTION OF THE INVENTION

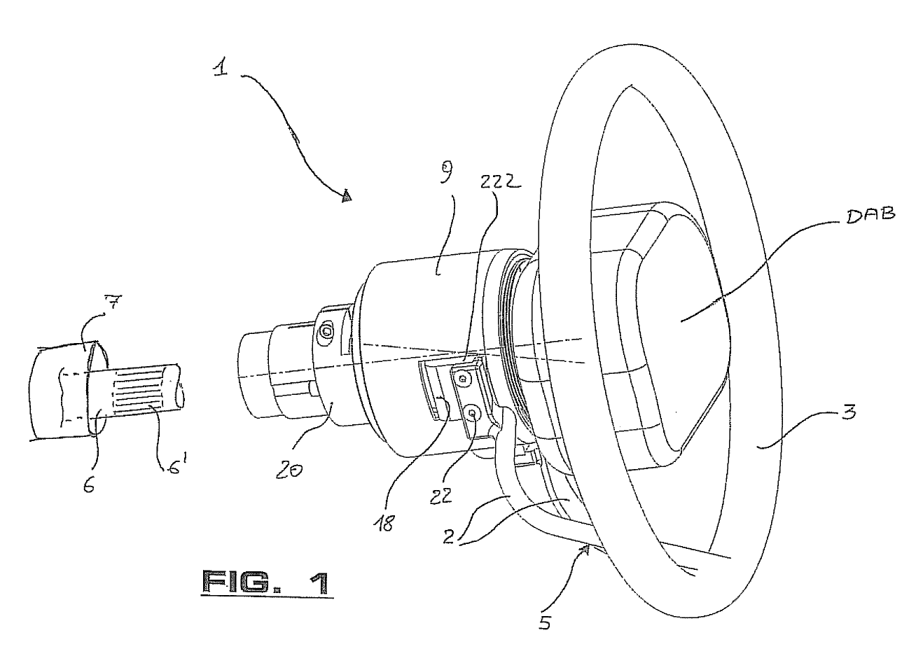

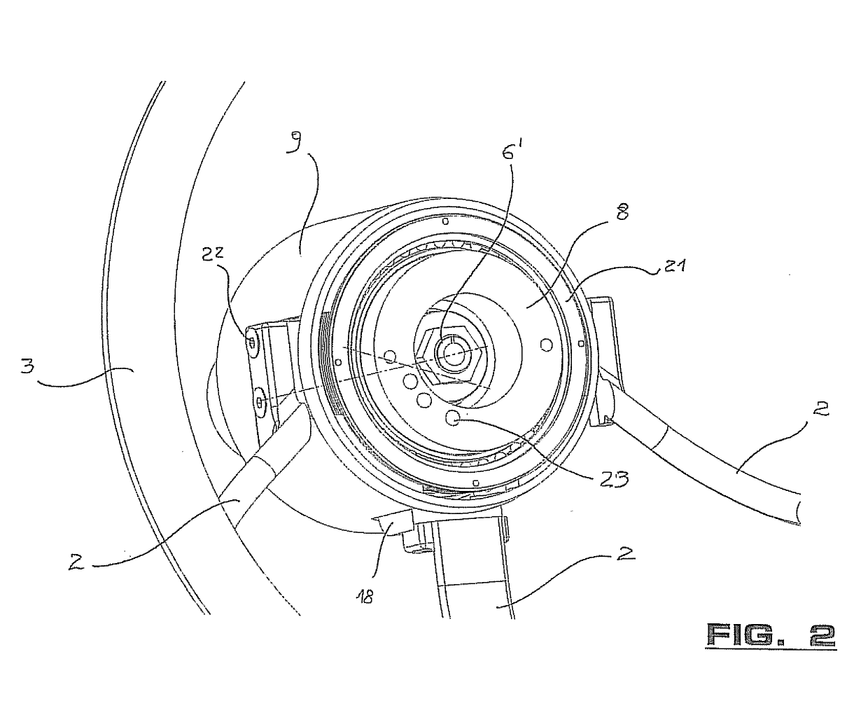

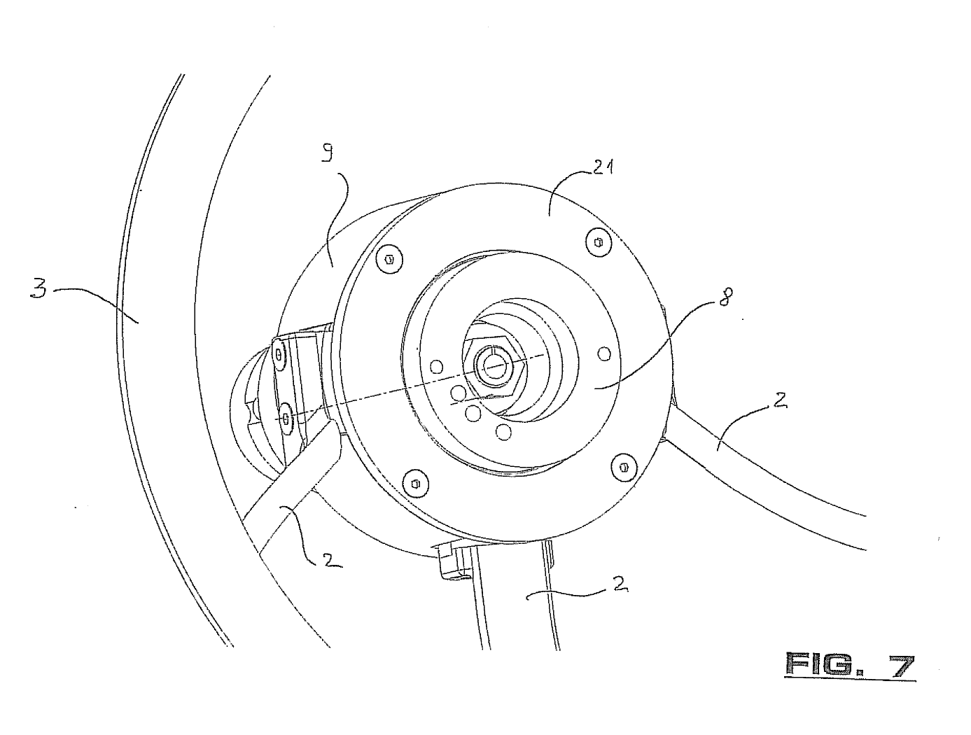

FIGS. 2 to 6 show a first embodiment of a steering wheel assembly according to the present invention. FIG. 7 to 11 show a second embodiment of a steering wheel assembly according to the present invention. FIG. 1 shows a steering wheel assembly according to the present invention (either the first embodiment or the second embodiment), in an assembled configuration.

With particular reference to FIG. 1, the steering wheel assembly 1 of the present invention comprises a steering wheel armature 5, which in turn comprises a rim 3 connected to a central hub portion 18 by at least one spoke 2, and preferably two or three spokes 2. The central hub portion 18 is fixable to a vehicle's steering column shaft 6, for instance a conventional steering column shaft 6 of a car. The steering wheel assembly 1 is provided with a centrally located stationary support member onto which a driver side airbag module DAB is fixable, as shown in FIG. 1, as well as other electric devices, such as switches, buttons, radio controls, navigation system buttons, etc.

The steering wheel assembly 1 shown in FIG. 1 is ready to be fitted on the steering shaft 6 of a vehicle. Installation can be completed simply by fitting the hub portion of the armature onto the machined portion 6 of the steering shaft 6.

The steering wheel assembly 1 shown in FIG. 2 is fitted on the machined portion 6 of the steering shaft 6 of the respective vehicle. For clarity the driver's side airbag module DAB is not shown except in FIG. 1. The steering wheel assembly includes a centrally located stationary support member 8 onto which a stationary device including the driver's side airbag module and/or other devices is to be coupled, so as not to be affected by rotation of the rim 3 by the driver.

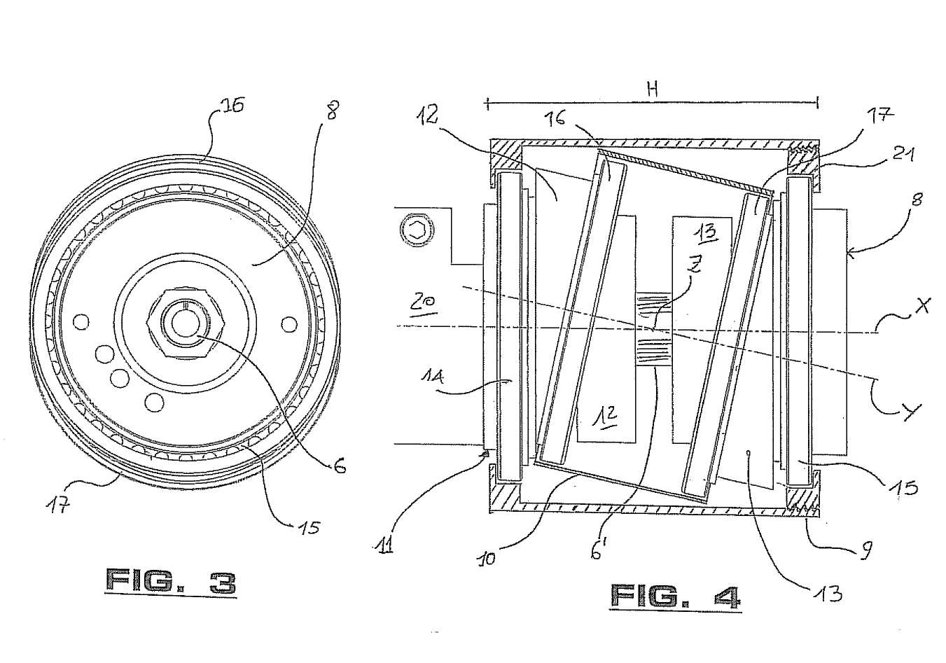

With reference to FIGS. 3 and 4, the steering wheel assembly 1 comprises a first drum 9 and a second drum 10. The term “drum” generally identifies an element having a main axis of rotation and any cross section, for instance circular, triangular, quadrangular, pentagonal, hexagonal, octagonal, etc., and an axis of rotation. In the preferred embodiment the drums have a circular section. A drum according to the invention may be made of a plurality of elements directly or indirectly connected to form a body rotatable around its axis. The drums 9, 10 may have any section, for instance circular, triangular, quadrangular, pentagonal, hexagonal, octagonal, etc. In the embodiment shown in the figures, the drums 9, 10 have a generally cylindrical shape and are preferably made of metal. In the embodiments shown in FIGS. 1-11 the second drum is located inside the first drum 9, but in general the steering wheel assembly may provide for the contrary.

In both the first and second embodiments, the first drum 9 is arranged to freely rotate about the steering shaft's axis of rotation X.

In the first embodiment the second drum 10 is arranged to freely rotate about a second axis Y, which is inclined with respect to and intersects the steering shaft's axis of rotation X, as shown best in FIG. 4. The second axis Y preferably intersects the steering shaft's axis of rotation X at the point Z. The angle between the axes X and Y is about 8 to 14 degrees, preferably 12 degrees. According to the preferred first embodiment, point Z of intersection between the axes X and Y is located at half the length H of the first drum 9, thereby minimizing the size of the entire steering wheel assembly 1.

The first bearing race member 12 and the second bearing race member 13 are positioned along the steering shaft 6, separated by the central hub portion 18 of the armature lying in between. The first bearing race member 12 is located nearer the front of the vehicle, while the second bearing race member 13 is located nearer the driver's seat. The central hub portion 18 does not rotate about the two bearing race members 12, 13, but remains separated from the same, to avoid any friction during operation of the steering wheel assembly. The distance between the first and the second bearing race members 12, 13 depends on the lengths of the two drums 9, 10. The first bearing race member 12 is fixed to a stationary part of the vehicle, such as the steering column shaft cover or “jacket”, for instance by clamps and screws.

The steering wheel assembly 1 is provided with a stationary support 11 having the function of providing a stationary support member 8 for the driver's side airbag DAB and/or other devices, and of supporting both drums 9, 10 on the respective axes X, Y. The support comprises a first bearing race member 12 and a second bearing race member 13, both positioned, at least in part, inside the first drum 9. The first bearing race member 12 is positioned on the side of the steering wheel assembly 1 facing the vehicle steering column, while the second bearing race member 13 is positioned on the side facing the driver's seat and the driver. The first and second bearing race members 12, 13 are preferably machined metal parts provided with seats, such as grooves, for lodging the bearings assisting rotation of the drums 9, 10. The steering shaft 6 rotates inside the bearing race members 12, 13 when the driver rotates the rim 3 but the bearing race members 12, 13 remain stationary. The bearing race members 12, 13 generally have an annular shape and the steering shaft 6 is inserted in their central hole. Preferably the shaft 6 rotates within the bearing race members 12, 13 without touching the internal surfaces thereof. In other words, the diameter of the central hole of the bearing race members 12, 13 is larger than diameter of the steering shaft 6, to avoid any friction during rotation of the steering shaft 6.

In both the first and the second embodiments, bearings are provided for supporting the first and the second drums so that they can be free to rotate. Preferably at least two bearings are provided for supporting each drum. The bearings may be ball bearings, roller bearings, self-oiling bearings, bearing linings, etc., which resist axial and radial loads and have axis of rotation strictly coaxial with the respective geometrical axis. The ball bearings may be of different types, for example radial ball bearings, i.e. bearings capable of resisting radial loads or radial-oblique ball bearings, i.e. bearings capable of resisting main radial loads and minor axial loads, axial-oblique ball bearings, i.e. bearings capable of resisting main axial loads and minor radial loads. Alternatively, the steering wheel assembly may be provided with both axial and radial ball bearings.

The bearings 14, 15, 16, 17 are seated on suitable bearing seats provided by the first and second bearing race members 11, 12. The skilled person will understand that if the drums 9, 10 are positioned on parallel spaced apart axes, the bearing seats are also parallel, while if the second drum 10 is inclined with respect to the first drum 9, the bearing seats of the bearings of the second drum 10 are inclined with respect to the bearing seats of the bearings of the first drum 9.

As shown best in FIGS. 3 and 4, the first drum 9 and the second drum 10 are supported by the bearing race members 12, 13 and bearings. Each drum 9, 10 is supported by at least two bearings. Preferably, the bearings are ball bearings. Two bearings 14, 15 support the external first drum 9 in rotation about the steering shaft's axis of rotation X only. Two bearings 16, 17 support the second drum 10 in rotation about the axis Y only. The drums 9, 10 are thus operating also as “connection elements” to provide a mechanical connection between the two bearing race members 12, 13 forming support 11. In other words, the steering wheel assembly provides for a direct connection of the first bearing race member 12 to a stationary support member of the vehicle and of the second bearing race member 13 to a stationary driver's side airbag DAB including element.

In general the bearings 14-17 may be ball bearings, roller bearings, self-oiling bearings, bearing linings, etc., which resist axial and radial loads and have axis of rotation strictly coaxial with the respective geometrical axis.

Preferably the ball bearings are “oblique” ball bearings that withstand loads applied not only in the radial direction but also minor axial loads. As it can be seen in FIGS. 3 and 4, the ball bearings 14, 15 are coaxial with the steering shaft's axis of rotation X, while the ball bearings 16, 17 are coaxial with the axis Y. In this way the drums 9, 10 are permitted to rotate only about the respective axis X, Y.

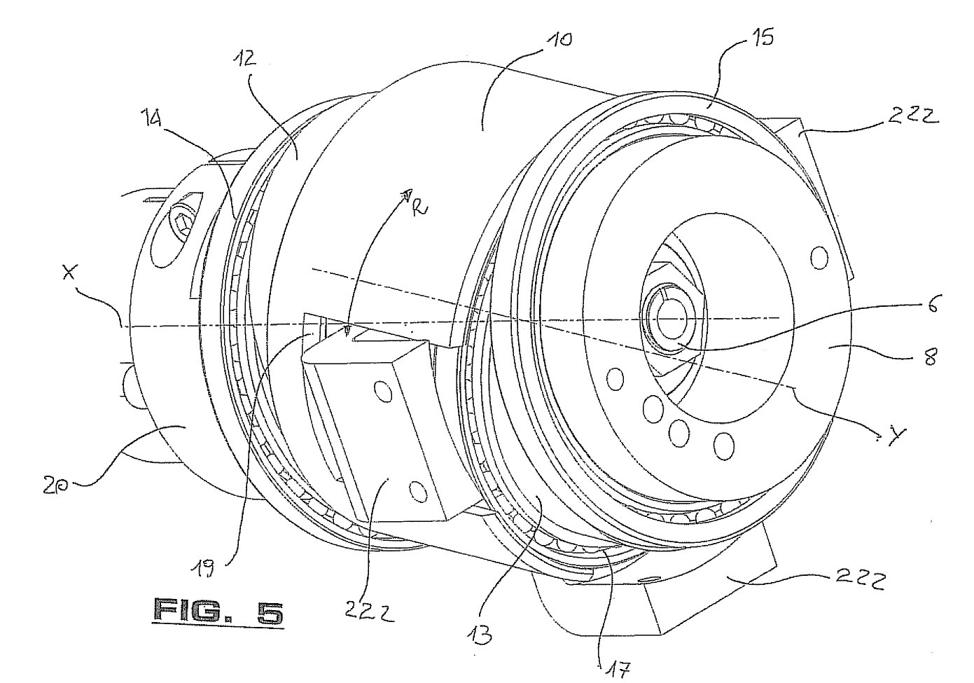

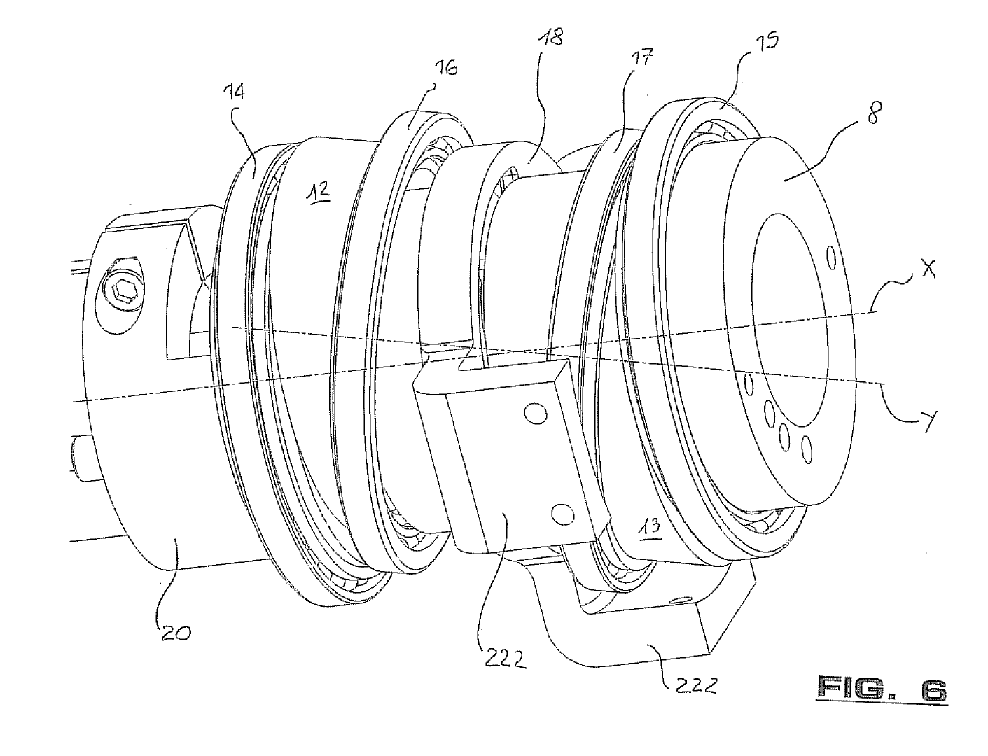

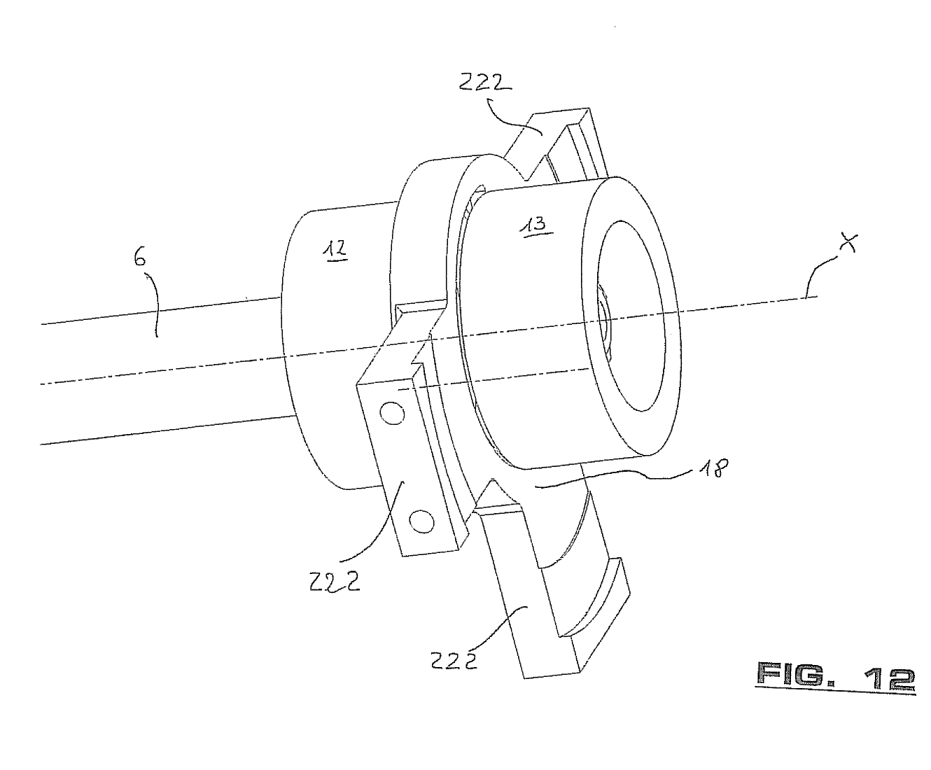

The first and second bearing race members 12, 13 are separated and spaced along the steering shaft's axis of rotation X, i.e. along the shaft 6 when the steering wheel assembly is fitted on it, by interposition of the steering wheel hub portion 18 (FIGS. 6 and 12). The hub portion 18, which may be a separate element coupled to the other parts of the armature 5 or may be a spoke 2 itself, engages the machined portion 6′ of the shaft 6 in such a way that any rotation imparted by the driver to the rim 3 is directly transmitted to the steering shaft 6. In FIG. 4 the spokes 2 and the hub portion 18 are not visible for sake of clarity. With reference to FIGS. 4 to 6, the spokes 2 of the steering wheel armature engage the sidewall of both the drums 9, 10 and connect to the hub portion 18, which is positioned internal the second drum 10. This is achieved by providing the drums 9, with lateral slots 19 through which the spokes 2 are received. FIG. 5 shows the steering wheel in transparency (the external drum 9 is not shown) wherein the spokes 2 are inserted in respective slots, apertures, holes, openings or the like. Rotations R of the spokes 2 following the rim 3 are directly transmitted to the drums 9, 10 by the same spokes 2 abutting the slots 19. The skilled person will understand that when rotation occurs, the spokes 2 generally may also slide a short distance in the slots 19 of the inclined second drum 10. In other words clockwise and counter-clockwise rotations imparted by the driver to the rim are directly transmitted to both the first drum and the second drum by the armature spokes engaging respective slots provided through the lateral wall of the drums.

The armature 5 may be manufactured as a single part, in that the rim 3, spokes 2 and hub portion 18 may be a single element. Preferably, as shown in FIGS. 1 to 12, the armature 5 is formed by coupling separate elements, such as the hub portion 18 to the spokes 2, which in turn are integral with the rim 3. Having a separate hub portion 18 simplifies the assembling of the steering wheel. In FIG. 1 screws 22 are used to lock the spokes 2 to the hub portion 18.

As the second or internal drum 10 is allowed to rotate about its axis Y only, and the first or external drum 9 is allowed to rotate about the steering shaft's axis of rotation X only, the support 11 has no degree of freedom, thereby remaining stationary. In other words the first and second bearing race members 12, 13 are not affected by rotation of the rim 3 by the driver and provide for a centrally located stationary support member 8 onto which a stationary device, e.g. including a driver side airbag module (DAB), can be mounted. In particular, the first bearing race member 12 is fixed to a coupling element 20 provided with means to be clamped on the shaft covering or jacket 7. As shown best in FIG. 4, the first bearing race member 12 is fixed to the coupling element 20 through the first drum 9. The second support member 13 provides a portion 8 extending through the driver side end of the first drum 9.

The weight of the stationary support 11, i.e. the weight of the first and second bearing race members 12, 13, is held by the steering column covering. Therefore possible oscillations of the hub portion 18, for example caused by geometrical defects of the machined portion 6 of the shaft 6, do not affect the driver's side airbag module, i.e. do not impart oscillations to the stationary support member 8.

Even if the first and the second bearing race members 12, 13 are not directly coupled, the link between them comprising the rotatable inclined drums 9, acts such that the bearing race members 12, 13 cannot rotate.

FIG. 2 shows an assembled configuration of the first embodiment, wherein the components internal to the first drum 9 are pressed within the first drum 9, with minimum clearance or no clearance at all, by a threaded ring 21 screwed in the first drum 9 end facing the driver side. The ring 21 surrounds the stationary support member 8.

The second embodiment of the steering wheel assembly according to the present invention is shown in FIGS. 7 to 11. In the second embodiment the second drum 10 is arranged to freely rotate about a second axis Y that is parallel to and spaced apart from the steering shaft's axis of rotation X and the column steering shaft 6. FIG. 7 shows a steering wheel assembly wherein the components internal to the first drum 9 are closed by a ring 21 clamped or screwed on the end of the first drum 9 facing the driver.

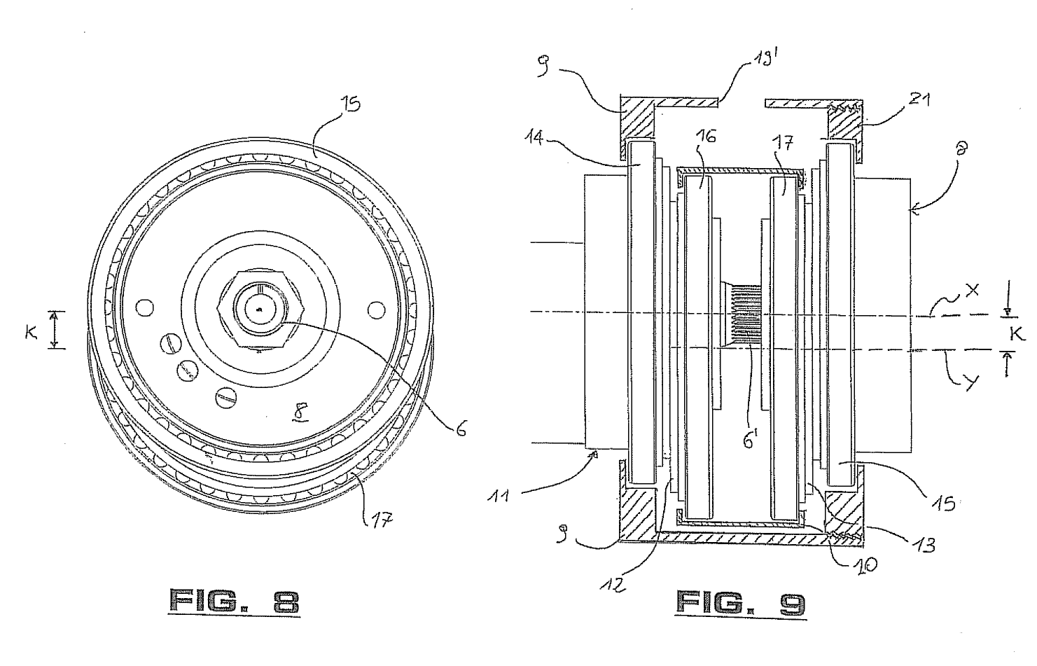

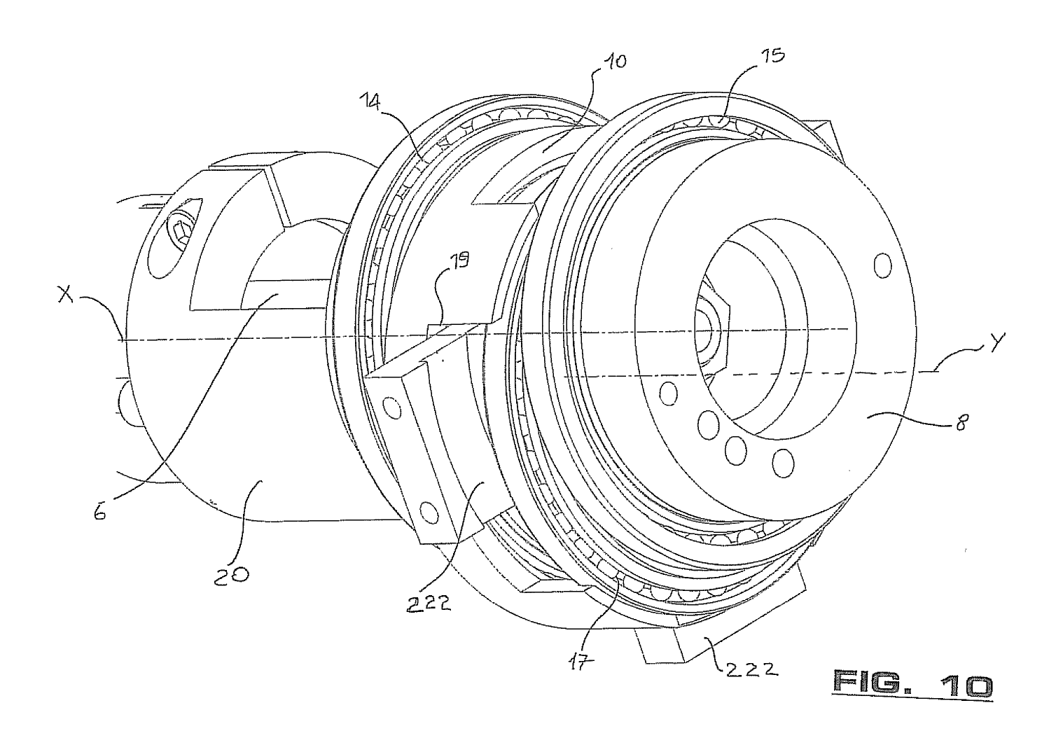

FIG. 9 corresponds to FIG. 4 of the first embodiment, but now the axes X and Y are parallel and spaced apart. The ball bearings 14, 15 supporting the first drum 9 in rotation about the steering shaft's axis of rotation X are arranged on the first and second bearing race members 12, 13, respectively, parallel to ball bearings 16, 17 of the second drum 10. This is accomplished by providing parallel seats, such as grooves, for the bearings on the bearing race members 12, 13. In FIG. 8 the offset K between the axes X, Y is about 5 to 15 mm.

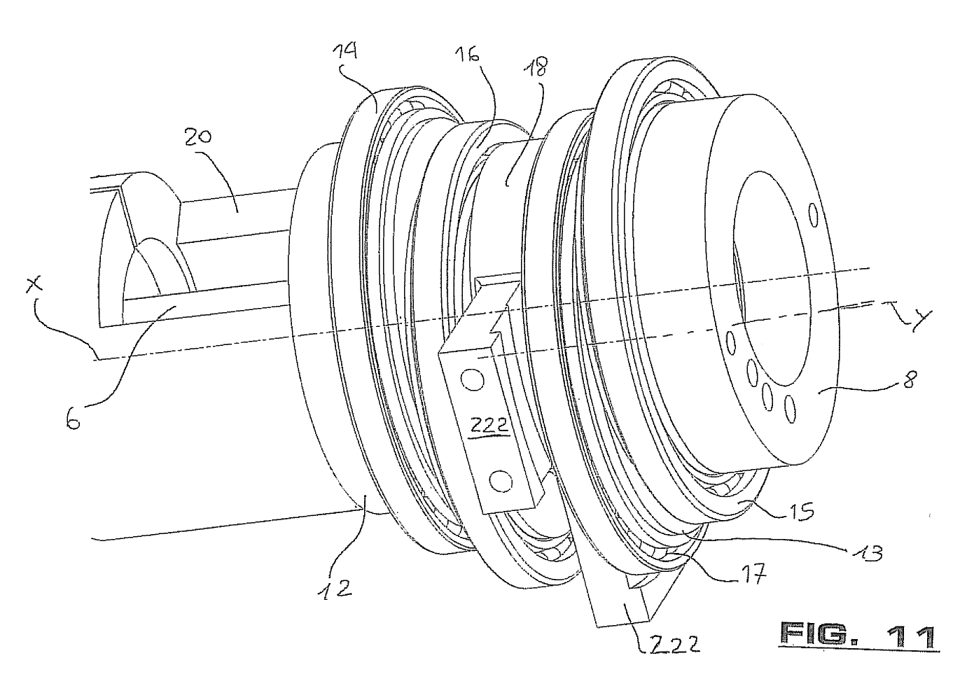

FIG. 10 shows the steering wheel assembly without the first drum 9 and FIG. 11 shows the steering wheel assembly without the drums 9, 10. The central hub portion 18 is provided with extensions 222 for allowing mechanical coupling with the spokes 2 and for rotating the drums 9, 10. The hub portion 18 is mechanically coupled to the machined portion 6 of the shaft 6 and separates the first bearing race member 12 and the second bearing race member 13 along the same steering shaft 6. The spokes 2, or equivalent extensions 222, engage corresponding slots 19 of the second drum 10 and slots 19 (FIG. 9) of the first drum 9, to impart rotation to both the drums 9, 10 on the axes X, Y imparted by the driver.

Functioning of the second embodiment is equivalent to operation of the first embodiment. The drums 9, 10 are rotated by the force imparted by spokes 2 on their slots 19, 19. As the first drum 9 can rotate about the axis X only and the second drum 10 can rotate about the axis Y only, no motion is transmitted to the support 11, i.e. the first and second bearing race members 12, 13 remain stationary. A driver's side airbag module, as the one shown in FIG. 1, can be securely fixed to the support 11, in particular to the portion 8 facing the driver and extending outside the first drum 9.

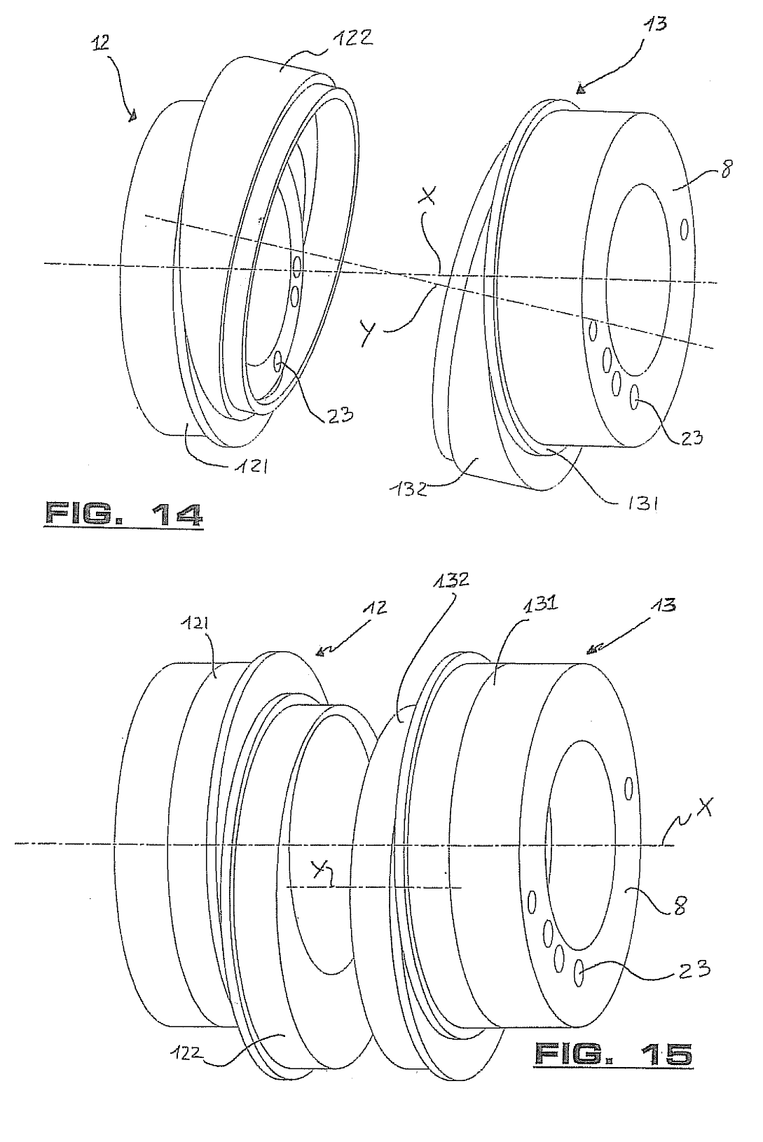

FIG. 14 shows in detail the first bearing race member 12 and the second bearing race member 13 of the first embodiment of the steering wheel assembly of the present invention. Generally, both members comprise a cylindrical portion 121, 131 that is symmetrical about the steering shaft's axis of rotation X for supporting respectively bearings 14, 15 coaxial with the same axis X. The bearings 14, 15 fit on the cylindrical portion 121, 131 or fit corresponding grooves provided on their surfaces. In particular, the ball bearings 14, 15 are coupled to the respective cylindrical portion 121, 131 by interference fitting. Each bearing race member 12, 13 also provides a second cylindrical portion 122, 132, preferably integral with the first portion 121, 131, which is symmetrical about the axis Y, to support respective bearings 16, 17 coaxial with the axis Y. Ball bearings 16, 17 fit on the respective cylindrical portion 122, 132 or fit correspondent grooves on the surface thereof. The ball bearings 16, 17 are coupled to the respective cylindrical portion 122, 132 by interference fitting.

FIG. 15 shows in detail the first bearing race member 12 and the second bearing race member 13 of the second embodiment of the steering wheel assembly of the present invention. Generally, both members comprise a cylindrical portion 121, 131 that is symmetrical about the steering shaft's axis of rotation X for supporting respectively the bearings 14, 15 coaxial with the same axis X. Each bearing race member 12, 13 also provides a second cylindrical portion 122, 132, preferably integral with the first portion 121, 131, which is symmetrical about axis Y, to support respective bearings 16, 17 coaxial with axis Y.

The first bearing race member 12 and the second bearing race member 13 are both provided with axial through-holes 23 wherein the electric conductors, such as wires, directed to the airbag module may pass.

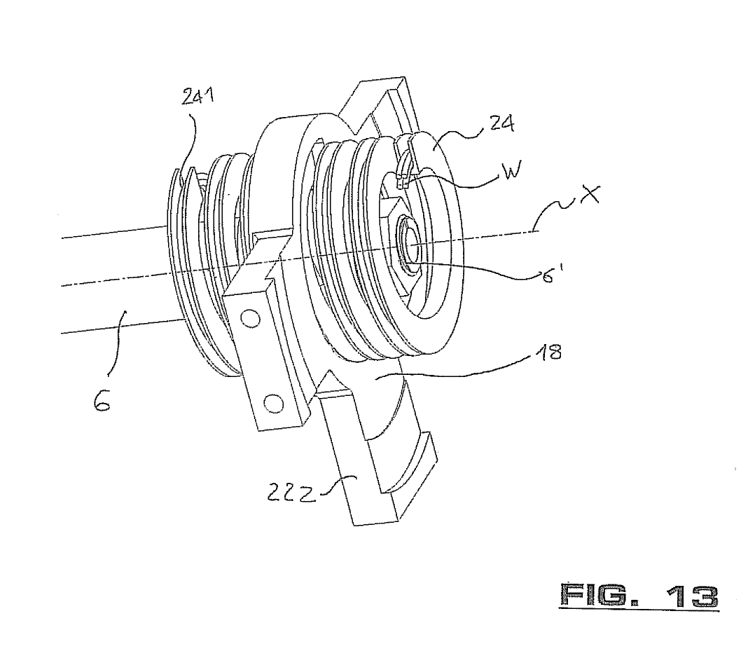

Electric conductors, usually needed for activation of the airbag module, can be lodged in a flexible coil, for instance made of a plastic material, of the type disclosed in EP-A-1707469. The coil 24 is shown in FIG. 13. The coil 24 brings the electric conductors W from a stationary support member of the vehicle, for instance the instrument board, trough the support 11, at the stationary support member 8 where the airbag module driver's side airbag module or other electric devices are to be installed. The plastic coil 24 is provided with a lateral groove 241 wherein the electric conductors W are lodged. The coil 24 extends around the shaft 6 and is internal to the first bearing race member 12 and the second bearing race member 13. The coil 24 is spiraled through the hub portion 18, as described in EP-A-1707469, when the steering wheel is rotated. The electrical conductors W, exiting the groove 241 of the coil 24, pass through the holes 23 of the support member 13 thereby reaching the driver's side airbag module on the stationary support member 8.

Alternatively the steering wheel assembly 1 is provided with two clock-spring connectors (not shown) coupled one to the other. A first connector can be arranged next to the first bearing race member 12 and the second connector can be arranged next to the second bearing race member 13. A hole is provided through the central hub portion 18 through which connectors are electrically coupled.

The steering wheel assembly of either the first or the second embodiment can be realized by inserting in the first drum 9, in sequence, the first bearing race member 12, with its ball bearings 14, 16 mounted on, the second drum 10, the central hub portion 18 of the armature, the second bearing race member 13, with its ball bearings 15, 17 mounted thereon, and by closing the first drum 9 with the cap 21, thereby pressing all the aforementioned components within the first drum 9 with minimum or null clearance. In the assembled configuration, shown in FIGS. 1, 2 and 7, the steering wheel is ready to be fitted on the steering shaft 6 and to be clamped on the covering 7.

Installation of the new steering wheel assembly on a vehicle can be accomplished in an extremely short time by simply sliding the hub portion onto the steering shaft 6, matching the machined teeth of both components. Then the coupling portion 20 is clamped onto the column shaft covering 7, thereby locking the support 11 against any rotation.

Advantageously, the steering wheel assembly 1 does not require toothed gears, such as planetary gears, which are expensive and require strict tolerances to avoid failures, and can be fitted on existing steering columns in a short time, with no need for redesigning the vehicle structures.

1. A steering wheel assembly comprising a steering wheel armature, including a rim, a central hub portion fixable to a vehicle column shaft and a spoke further comprising:
a first drum that is freely rotatable only about the steering shaft's axis of rotation and has a sidewall,
a second drum that has a sidewall and is freely rotatable about a second axis only, the second axis being either parallel to and spaced apart from the steering shaft's axis of rotation or intersects the steering shaft's axis of rotation,
a means for providing a centrally located stationary support member for attachment to an side airbag module, and
wherein both the first drum and the second drum are rotated around their respective axes by the spoke engaging their sidewalls.

2. A steering wheel assembly according to claim 1, wherein the second drum is inside the first drum.

3. A steering wheel assembly according to claim 1, wherein said means for providing a centrally located stationary support member comprises two bearing race members spaced along the steering shaft's axis of rotation.

4. A steering wheel assembly according to claim 2, wherein the first drum is supported coaxial with the steering wheel shaft by at least two bearings and the second drum is supported parallel to and spaced apart from or inclined with respect to the first drum by at least two bearings.

5. A steering wheel assembly according to claim 3, wherein at least two bearings are fit on each of the bearing race members.

6. A steering wheel assembly according to claim 1, wherein the stationary means comprises a stationary first bearing race member, supporting at least one bearing for the first drum, and a stationary second bearing race member, for supporting at least one bearing for the second drum, the first bearing race member and the second bearing race member being separated along the steering shaft by the central hub portion of the armature and connected together by said first and second drums.

7. A steering wheel assembly according to claim 2, wherein the second axis is inclined with respect to the steering shaft's axis of rotation of about 8 to 14 degrees.

8. A steering wheel assembly according to claim 2, wherein the steering shaft's axis of rotation and the second axis intersect at a point halfway along the length of the first drum.

9. A steering wheel assembly according to claim 1, further comprising an airbag module attached to the centrally located stationary support member, wherein the airbag module remains stationary when the rim of the steering wheel armature is rotated.

10. A steering wheel assembly comprising a steering wheel armature, including a rim, a central hub portion fixable to a vehicle column shaft and a spoke further comprising:
a first drum that is freely rotatable only about the steering shaft's axis of rotation and has a sidewall,
a second drum located inside the first drum, the second drum having a sidewall, the second drum is freely rotatable about a second axis only, the second axis being parallel to and spaced apart from the steering shaft's axis of rotation,
a means for providing a centrally located stationary support member for attachment to an airbag module, and
wherein both the first drum and the second drum are rotated around their respective axes by the spoke engaging their sidewalls.

11. A steering wheel assembly according to claim 10, further comprising an airbag module attached to the centrally located stationary support member, wherein the airbag module remains stationary when the rim of the steering wheel armature is rotated.

12. A steering wheel assembly comprising a steering wheel armature, including a rim, a central hub portion fixable to a vehicle column shaft and a spoke further comprising:
a first drum that is freely rotatable only about the steering shaft's axis of rotation and has a sidewall,
a second drum located inside the first drum, the second drum having a sidewall, the second drum is freely rotatable about a second axis only, the second axis intersecting the steering shaft's axis of rotation,
a means for providing a centrally located stationary support member for attachment to an airbag module, and
wherein both the first drum and the second drum are rotated around their respective axes by the spoke engaging their sidewalls.

13. A steering wheel assembly according to claim 12, wherein the steering shaft's axis of rotation and the second axis intersect at a point halfway along the length of the first drum.

14. A steering wheel assembly according to claim 12, wherein the second axis is inclined with respect to the steering shaft's axis of rotation of about 8 to 14 degrees.

15. A steering wheel assembly according to claim 12, further comprising an airbag module attached to the centrally located stationary support member, wherein the airbag module remains stationary when the rim of the steering wheel armature is rotated.
